(19) United States
(12) Patent Application Publication
(10) Pub. No.: US 2018/0225382 A1
(43) Pub. Date: Aug. 9, 2018

(54) SYSTEM AND METHOD FOR AUTOMATIC CREATION OF ONTOLOGICAL DATABASES AND SEMANTIC SEARCHING

(71) Applicant: Fractal Industries, Inc., Reston, VA (US)

(72) Inventors: Jason Crabtree, Vienna, VA (US); Andrew Sellers, Colorado Springs, CO (US)

(21) Appl. No.: 15/847,443

(22) Filed: Dec. 19, 2017

Related U.S. Application Data
(63) Continuation-in-part of application No. 15/790,457, filed on Oct. 23, 2017.
Application No. 15/790,457 is a continuation-in-part of application No. 15/790,327, filed on Oct. 23, 2017.
Application No. 15/790,327 is a continuation-in-part of application No. 15/616,427, filed on Jun. 7, 2017.
Application No. 15/616,427 is a continuation-in-part of application No. 15/141,752, filed on Apr. 28, 2016.
Application No. 15/141,752 is a continuation-in-part of application No. 15/091,563, filed on Apr. 5, 2016.
Application No. 15/091,563 is a continuation-in-part of application No. 14/986,536, filed on Dec. 31, 2015.
Application No. 14/986,536 is a continuation-in-part of application No. 14/925,974, filed on Oct. 28, 2015.
Application No. 14/925,974 is a continuation-in-part of application No. 15/616,427, filed on Jun. 7, 2017.
Application No. 15/616,427 is a continuation-in-part of application No. 14/925,974, filed on Oct. 28, 2015.
Application No. 14/925,974 is a continuation-in-part of application No. 15/489,716, filed on Apr. 17, 2017.
Application No. 15/489,716 is a continuation-in-part of application No. 15/409,510, filed on Jan. 18, 2017.
Application No. 15/409,510 is a continuation-in-part of application No. 15/379,899, filed on Dec. 15, 2016.
Application No. 15/379,899 is a continuation-in-part of application No. 15/376,657, filed on Dec. 13, 2016.
Application No. 15/376,657 is a continuation-in-part of application No. 15/237,625, filed on Aug. 15, 2016.
Application No. 15/237,625 is a continuation-in-part of application No. 15/206,195, filed on Jul. 8, 2016.
Application No. 15/206,195 is a continuation-in-part of application No. 15/186,453, filed on Jun. 18, 2016.
Application No. 15/186,453 is a continuation-in-part of application No. 15/166,158, filed on May 26, 2016.
Application No. 15/166,158 is a continuation-in-part of application No. 15/141,752, filed on Apr. 28, 2016.
(60) Provisional application No. 62/568,298, filed on Oct. 4, 2017.
(60) Provisional application No. 62/568,291, filed on Oct. 4, 2017.

(51) Int. Cl. G06F 17/30; G06N 5/04

(52) U.S. Cl. CPC G06F 17/30867; G06N 5/04; G06F 17/30734

(57) ABSTRACT

A system for automatically creating and merging ontological databases and for conducting context-based searches using those databases. The system has an automated ontology engine which receives data, analyzes it to identify relationships between its elements, and organizes it into ontologies. The automated index generator creates a searchable index of the created ontologies. The semantic search engine performs context-based searches based on the index of ontologies and contextual information about the search query and the user.

### CROSS-REFERENCE TO RELATED APPLICATIONS

This application is a continuation-in-part of U.S. patent application Ser. No. 15/790,457, titled “IMPROVING A DISTRIBUTABLE MODEL WITH BIASES CONTAINED WITHIN DISTRIBUTED DATA”, filed on Oct. 23, 2017, which claims priority to U.S. provisional patent application 62/568,298, titled “DISTRIBUTABLE MODEL WITH BIASES CONTAINED IN DISTRIBUTED DATA”, filed on Oct. 4, 2017, and is also a continuation-in-part of U.S. patent application Ser. No. 15/790,327 titled “IMPROVING A DISTRIBUTABLE MODEL WITH DISTRIBUTED DATA”, filed on Oct. 23, 2017, which claims priority to U.S. provisional patent application 62/568,291 titled “DISTRIBUTABLE MODEL WITH DISTRIBUTED DATA”, filed on Oct. 4, 2017, and is also a continuation-in-part of U.S. patent application Ser. No. 15/141,752, titled “SYSTEM FOR FULLY INTEGRATED CAPTURE, AND ANALYSIS OF BUSINESS INFORMATION RESULTING IN PREDICTIVE DECISION MAKING AND SIMULATION” and filed on Apr. 28, 2016, which is a continuation-in-part of U.S. patent application Ser. No. 14/925,974, titled “RAPID PREDICTIVE ANALYSIS OF VERY LARGE DATA SETS USING THE DISTRIBUTED COMPUTATIONAL GRAPH” and filed on Oct. 28, 2015, and is also a continuation-in-part of U.S. patent application Ser. No. 14/986,536, titled “DISTRIBUTED SYSTEM FOR LARGE VOLUME DEEP WEB DATA EXTRACTION”, and filed on Dec. 31, 2015, and is also a continuation-in-part of U.S. patent application Ser. No. 15/091,563, titled “SYSTEM FOR CAPTURE, ANALYSIS AND STORAGE OF TIME SERIES DATA FROM SENSORS WITH HETEROGENEOUS REPORT INTERVAL PROFILES”, and filed on Apr. 5, 2016, the entire specifications of each of which are incorporated herein by reference.

This application is also a continuation-in-part of U.S. patent application Ser. No. 15/616,427, titled “RAPID PREDICTIVE ANALYSIS OF VERY LARGE DATA SETS USING AN ACTOR-DRIVEN DISTRIBUTED COMPUTATIONAL GRAPH”, filed on Jun. 7, 2017, and is also a continuation-in-part of U.S. patent application Ser. No. 15/489,716, titled “REGULATION BASED SWITCHING SYSTEM FOR ELECTRONIC MESSAGE ROUTING” and filed on Apr. 17, 2017, which is a continuation-in-part of U.S. patent application Ser. No. 15/409,510, titled “MULTI-CORPORATION VENTURE PLAN VALIDATION EMPLOYING AN ADVANCED DECISION PLATFORM” and filed on Jan. 18, 2017, which is a continuation-in-part of U.S. patent application Ser. No. 15/379,899, titled “INCLUSION OF TIME SERIES GEOSPATIAL MARKERS IN ANALYSES EMPLOYING AN ADVANCED CYBER-DECISION PLATFORM” and filed on Dec. 15, 2016, which is a continuation-in-part of U.S. patent application Ser. No. 15/376,657, titled “QUANTIFICATION FOR INVESTMENT VEHICLE MANAGEMENT EMPLOYING AN ADVANCED DECISION PLATFORM” and filed on Dec. 13, 2016, which is a continuation-in-part of U.S. patent application Ser. No. 15/237,625, titled “DETECTION MITIGATION AND REMEDIATION OF CYBERATTACKS EMPLOYING AN ADVANCED CYBER-DECISION PLATFORM” and filed on Aug. 15, 2016, which is a continuation-in-part of U.S. patent application Ser. No. 15/206,195, titled “SYSTEM FOR AUTOMATED CAPTURE AND ANALYSIS OF BUSINESS INFORMATION FOR RELIABLE BUSINESS VENTURE OUTCOME PREDICTION” and filed on Jul. 8, 2016, which is continuation-in-part of U.S. patent application Ser. No. 15/186,453, titled “SYSTEM FOR AUTOMATED CAPTURE AND ANALYSIS OF BUSINESS INFORMATION FOR RELIABLE BUSINESS VENTURE OUTCOME PREDICTION” and filed on Jun. 18, 2016, which is a continuation-in-part of U.S. patent application Ser. No. 15/166,158, titled “SYSTEM FOR AUTOMATED CAPTURE AND ANALYSIS OF BUSINESS INFORMATION FOR SECURITY AND CLIENT-FACING INFRASTRUCTURE RELIABILITY”, and filed on May 26, 2016, the entire specification of each of which is incorporated herein by reference in its entirety.

### BACKGROUND OF THE INVENTION

### Field of the Invention

The present invention is in the field of computer systems and algorithms for context-based searching and complex knowledge data set development.

### Discussion of the State of the Art

Early computer search algorithms were character or keyword based, and performed basic searches of a string of characters within a dataset, returning the results in the order found. The first generation of internet search engines did much the same thing, returning a series of results containing keywords in the order found. As the amount of information available on the internet grew larger, it became more important to improve the relevance of the results returned. This need led Google to develop its PageRank algorithm, which ranked searched results based on a number of factors, and showed more “relevant” results first. This was a dramatic improvement over existing search engines at the time. Now, however, there is so much information available that a keyword-based ranking algorithm no longer provides the level of sophistication required to capture the complexity of knowledge and data available.

As the field of knowledge engineering grows, there has been an increased focus on the use of ontologies to classify information. A number of ontological databases exist, most related to a particular field of application (e.g., medicine, scientific information retrieval, business organization, etc.). Existing ontologies are manually created, which is a labor-intensive and time consuming process, and limits the scope of each ontology. Merging of ontologies is also a manual process, limiting the creating of broader ontologies that represent most or all of human knowledge.

One major goal in the creation of ontologies is semantic searching, which is searching based on a complex understanding of human thought, rather than based primarily on keywords. Semantic searching remains an unrealized goal for several reasons. First, existing ontologies are not complex enough to encompass a sufficient breadth of human knowledge to enable semantic searches. Second, the ontology creation process is manual, and not likely to expand to include a broad enough portion of human knowledge to allow the use of semantic searches in the near future. Third, semantic searches require a level of sophistication in ontologies that does not yet exist. To perform a genuine semantic search would require ontologies capable of distinguishing complex human expressions such as satire, parody, deception, sarcasm, and other indirect and unexpressed forms of meaning.

There have been attempts to create semantic search engines (e.g., Falcons, Sindice, Semantic Web Search, SWSE—Semantic Web Search Engine), but none have yet displaced the predominantly keyword based strategies because they are not capable of generating the complex indices necessary for true semantic searching in a commercially realizable manner.

What is needed is a system automatically creates and merges ontologies to a level of sophistication that allows semantic searches based on those ontologies

### SUMMARY OF THE INVENTION

The inventor has developed a system that provides a complex, sophisticated, multi-variate analysis applicable to many fields in computer science and engineering. One of the fields in which an embodiment of this system can be employed is in algorithms for organization and searching of complex collections of knowledge.

In a preferred embodiment, the system gathers a large amount of information from public sources, private databases, or both, and allows users to perform semantic searches which provide optimized results beyond those provided by text-based or ranking-based search engines. Using machine learning algorithms that are an aspect of the embodiment, the system organizes the information into one or more complex ontological databases that are optimized based on a multiplicity of hierarchies, taxonomies, ontologies, and other relations between and among the elements in the database. In another aspect of the embodiment, the system allows for semantic searches of the databases, taking into account a multiplicity of factors beyond the text of the search query to predict the intent of the user, and to provide search results that closely match the user's intent, even where such intent is unstated in the search query.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram showing an embodiment in which ontologies are used to provide semantic search capabilities through a semantic search engine.

FIG. 2 is an example of how an aspect of an embodiment 200 might predict the user's intent in response to an ambiguous search query.

FIG. 3 is a diagram showing an exemplary list of possible information sources for input to the previously disclosed automated ontology engine

FIG. 4 is a block diagram illustrating an exemplary hardware architecture of a computing device used in various embodiments of the invention.

FIG. 5 is a block diagram illustrating an exemplary logical architecture for a client device, according to various embodiments of the invention.

FIG. 6 is a block diagram illustrating an exemplary architectural arrangement of clients, servers, and external services, according to various embodiments of the invention.

FIG. 7 is another block diagram illustrating an exemplary hardware architecture of a computing device used in various embodiments of the invention.

FIG. 8 is a method diagram showing the steps involved in the automated creation of ontologies and searchable indices.

FIG. 9 is a method diagram showing the steps involved in a semantic search using an indexed ontological database.

### DETAILED DESCRIPTION

The inventor has conceived, and reduced to practice, a system for analysis, organization, and searching of complex collections of knowledge called ontologies. These automatically generated ontologies will constitute a dramatic improvement over existing ontologies, and will represent a large body of human knowledge at a level of sophistication capable of distinguishing complex human expressions such as satire, parody, deception, sarcasm, and other indirect and unexpressed forms of meaning. Such sophisticated ontologies will allow for complex operations that currently require human level understanding, such as semantic searches.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

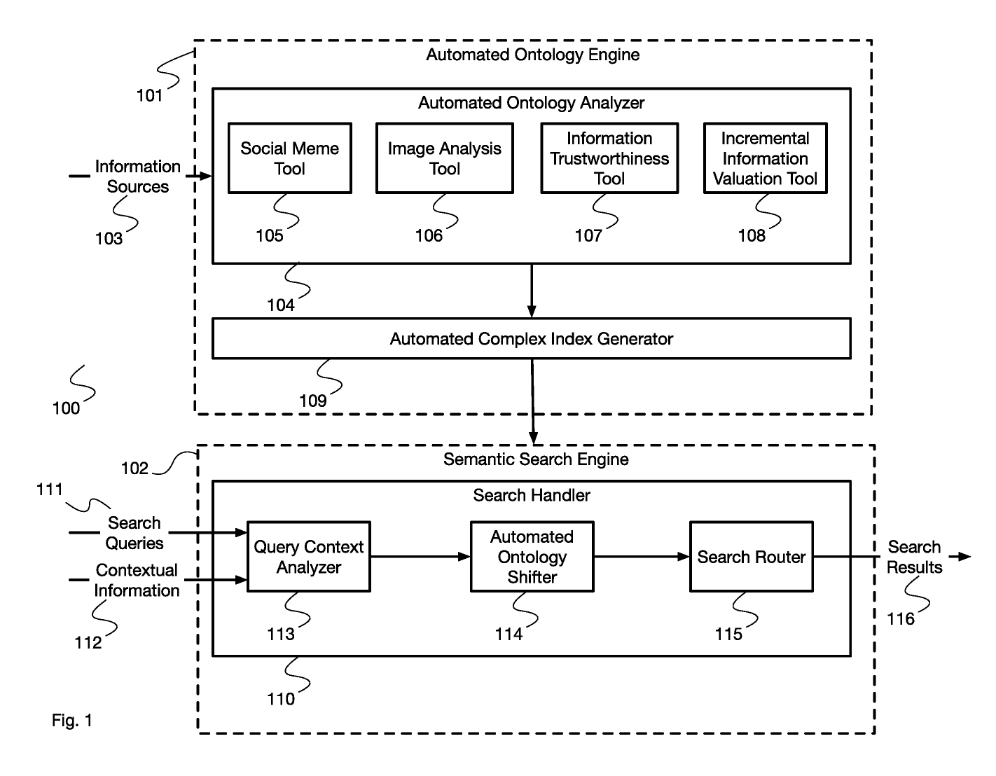

FIG. 1 is a block diagram showing an embodiment 100 in which ontologies are generated by the automated ontology engine 101 and used to provide semantic search capabilities through a semantic search engine 102. In this embodiment, the automated ontology generator 102 receives information 103 from a variety of public and private sources. This information may either be gathered by another aspect by crawling the web for publicly available information, or the information may be provided information from public or private databases. Ideally, the information received would include not just information about things, but also information about their relationships from existing hierarchies, taxonomies, ontologies, dictionaries, thesauruses, website page ranks, website relational content, and similar relational structures. As information is received, the automated ontology engine 104 runs the information through a variety of tools which perform a multi-variate analysis on the information. For example, a social meme tool 105 would evaluate the information for classification based on the breadth and persistence of certain memes (cultural ideas which are distributed by members of a group and which have an impact on the thinking of that group). An image analysis tool 106 (see prior disclosures) would be used to perform complex image analysis and classification beyond the useful, but simplistic, image collections available on the internet today such as ImageNet. A trustworthiness tool 107 would be used in conjunction with the social meme tool to determine the veracity of information by capturing a range of human understandings of information that current search engines are unable to distinguish, such as sentiment, intent, emotions, satire, underlying motivations, and the like. Based in part on information from other tools, an information valuation tool 108 would be able to price the incremental value of changes and updates to information. Other tools could be added to increase the functionality of the system. As the automated ontology generator completes its analysis, the newly-generated ontologies are passed on to the automated complex index generator 109 for creation of a network of indices relating the information to ontologies, hierarchies, taxonomies, trustworthiness rankings, valuations, and other classifications and groupings. These indices are then made available to the search handler 110 for use in performing semantic searches. As search queries 111 are received into the query context analyzer 113, contextual information is gathered about the search query itself and about the user making the query 112. A contextual analysis is performed which comprises analysis of the query itself in conjunction with detailed information about the context in which the query is occurring, and contextual information about the user. For example, the query itself is analyzed for syntax, the language or dialect or the search, lists of common language ambiguities, search history and selections of users with similar characteristics, dictionary and thesaurus entries, natural language search engines outputs, etc. The contextual analysis might also include such things as the user's age, sex, height, weight, location, food preferences, prior search history, etc. The results of the query context analyzer would be sent to the automated ontology shifter 114, which would compare the query analysis with the complex index database to determine the user's intent, even where such intent is unstated. The ontology shifter would shift the focus of the search to the appropriate ontology, and provide the results tot the search router 115, which would provide search results 116 to the user most closely matching the user's predicted intent.

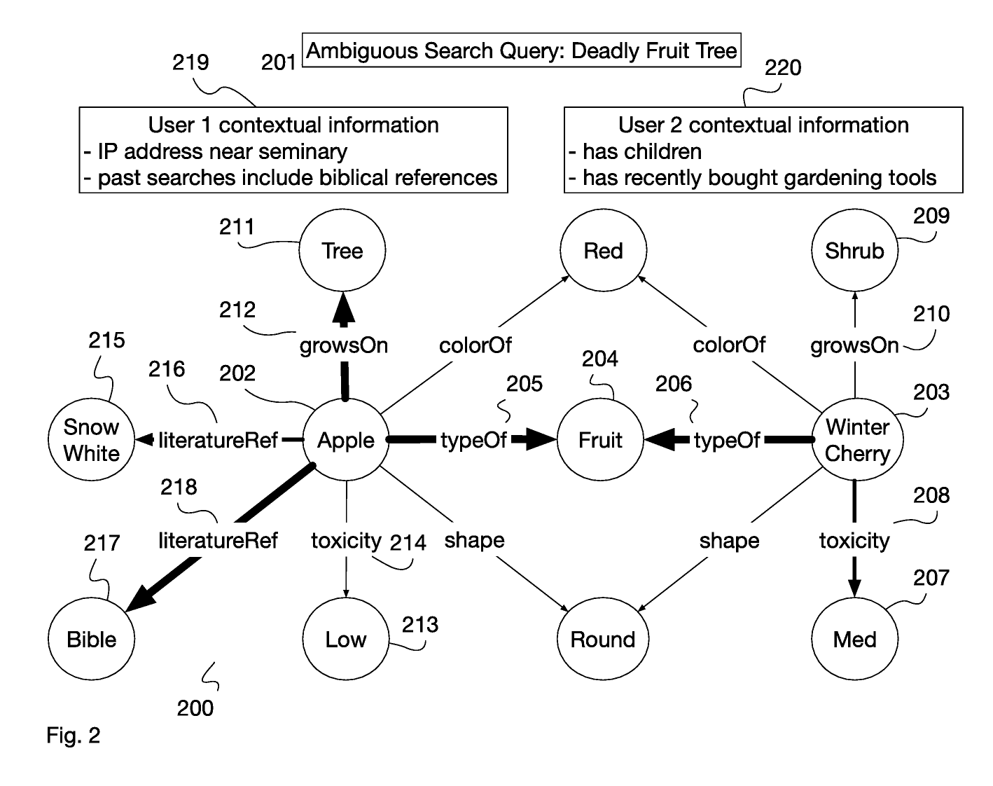

FIG. 2 is an example of how an aspect of an embodiment 200 might predict the user's intent in response to an ambiguous search query. In this example, a knowledge graph is used by the previously disclosed query context analyzer 113 and automated ontology shifter 114 to determine the intent of two different users from the same ambiguous search query, even where that intent is unstated. In this example, elements in the knowledge graph are represented by circular shapes called “nodes”, and the relationships between them are represented by lines called “edges”. The nodes represent things, and the edges represent relationships between the things. The lines are weighted to indicate how closely they match certain elements of the search query. In this simplified example, both users have entered the ambiguous search query “deadly fruit tree” 201. Initially, performing an analysis of the query only, two possible meanings could be an apple 202 or a mildly poisonous fruit called a winter cherry 203. Both the apple and winter cherry are of the type fruit 204, so the apple/fruit edge 205 and the winter cherry/fruit edge 206 are heavily weighted, indicating that they closely match elements of the search query. The winter cherry is mildly poisonous 207, so the winter cherry/toxic edge 208 is moderately weighted. The apple is non-toxic 213, so the apple/non-toxic edge 214 is lightly weighted. Considering just these two variables, it would appear that the user intended to find the winter cherry. However, the winter cherry grows on a shrub 209, so the winter cherry/shrub edge 210 is lightly weighted. The apple, on the other hand, grows on a tree 211, which is one of the search terms, and so the apple/tree edge 212 is heavily weighted. On balance, choosing only between these two items, it appears that the user intended to find references to an apple. However, the apple itself is not toxic, and references to toxic apples appear primarily in literature. In this simplified example, the remaining possibilities are the fairy tale Snow White & the Seven Dwarves 215, wherein the main character is given a poisoned apple, and the biblical reference 217 to the story of Genesis, wherein an apple grows on a tree and “poisons” the minds of Adam and Eve. Since the Snow White story does not contain references to apples growing on trees, but the biblical story does, the apple/Snow White edge 216 is moderately weighted, and the apple/Bible edge 218 is heavily weighted. At the completion of the analysis of the query only, the weighting of the knowledge graph suggests that the query is related to the biblical story of Genesis. Now, however, contextual information about the users may be included in the analysis to better predict the user's unstated intent. The contextual information about User 1 219 includes the fact that the user's IP address is located near a theological seminary and that the user has previously searched for biblical quotations. This context strengthens the idea that intent of the user in searching for “deadly fruit tree” was to find the biblical reference to the “fruit of the poisonous tree”. The contextual information about User 2 220, on the other hand, includes information available from public records that the user has children, and has recently bought a shovel, wheelbarrow, and other landscaping tools. Considering this additional context, it is considerably less likely that the literature references are what the user intended, and more likely that the user is interested in the toxicity of certain fruits. This leads the system to predict that the user is, in fact, interested in obtaining information on winter cherries instead of apples, despite the fact that winter cherries grow on shrubs and the search query itself includes the word “tree”.

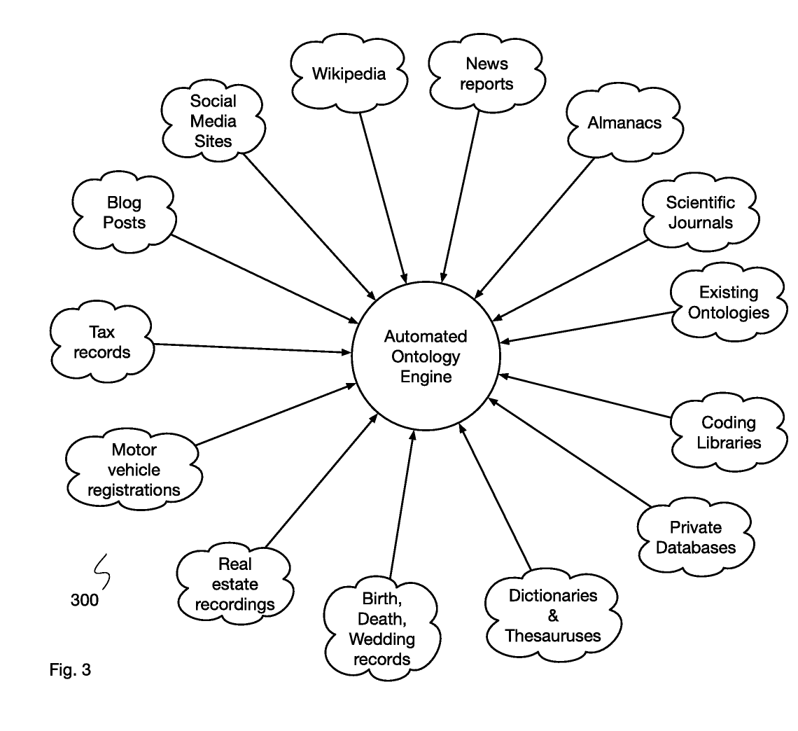

FIG. 3 is a diagram 300 showing an exemplary list of possible information sources for input to the previously disclosed automated ontology engine 101. Most of these sources are publicly available and the information contained therein can be acquired by automated web crawlers.

### Detailed Description of Exemplary Aspects

Human beings use a variety of methods to organize and store knowledge and recall that knowledge at a later time for use. The simplest forms of knowledge organization are unorganized collections and simple lists. Taxonomies are a more sophisticated forms of knowledge organization in which similar things are organized into a hierarchical tree with branches based on similar characteristics. Scientific classification of flora and fauna is, perhaps, the most well-known example of taxonomical organization, where each plant or animal is placed into a particular branch of a much larger tree based on the similarities of its external and internal structures to living things higher in the tree. Ontological classification goes one step further, and allows for flexible organization of knowledge based on arbitrary relationships. For example, a collection of fruits can be grouped according to their type (e.g. apple), shape (e.g., round, oval, etc.), color, sweetness, acidity, etc. Each grouping will yield a different set of characteristics and may be useful for different purposes. For example, grouping based on acidity will yield citrus fruits versus other fruits, which is a fairly common and expected grouping. Grouping based on the color red, however, will put certain varieties of apples, cherries, bell peppers, and tomatoes together, which is an atypical grouping that may have organizational benefits, depending on the intended use of the knowledge.

The term “ontology” refers to a formal naming and definition of the types, properties, and interrelationships of the entities that exist in a particular domain of discourse. Ontologies are a method of classification of things and their relationships with other things. They are related to, but more flexible than, taxonomies, hierarchies, and class definitions. The term ontologies, as used herein, has the meaning associated with information and computer science, rather than the definition used in philosophy of classifying things as they exist in reality.

A “domain-specific ontology” refers to the meaning of a concept within a particular ontological domain (i.e., a set of reference ideas that establishes context). For example, the word “card” has many different meanings, depending on the ontological domain (context) in which it is used. In the domain of poker, the term “card” would refer to a “playing card” as used in playing the game of poker. In the domain of computer software, the term “card” may refer to the antiquated “punch card” form of information storage. In the domain of computer hardware, the term “card” could refer to a “video card”, an “SD card” (a type of memory storage device), or similar pieces of hardware.

The term “upper ontology” refers to a model of things that are common across a range of domain-specific ontologies. Existing upper ontologies are typically still limited to a particular field of application (e.g., medicine, scientific information retrieval, business organization, etc.). Importantly, existing ontologies are manually created. Partial or full automation of the ontology creation process is an aspect of this disclosure. Another aspect of this disclosure is automated creation of an upper ontology of sufficient sophistication to allow genuine semantic searching.

Searches are a way for us to sort through and select stored knowledge based on our intended use. There are a variety of different search methodologies, from simple to complex.

Keyword searches are the most basic form of searching. In keyword searches, the search algorithm simply searches for instances of that keyword and provides results in the form of a list of documents in which that keyword was found. The person conducting the search has a certain concept in mind, and enters a keyword or phrases in an attempt to provide a sufficient description that the search engine will produce relevant results. The person conducting the search has to sift through the results to determine whether each document falls within the classification of things for which the person was searching. When the results are returned in the form of a list of documents, the person has to sift through the results to determine whether each document falls within the classification of things for which the person was searching. In other words, it is the user who sorts the list of search results into ontological or hierarchical classifications to determine whether the result is relevant to the user's needs.

Syntax-based searches are keyword searches that attempt to provide more relevant results by looking at the keywords in their syntactic context. Most current search engines use syntactic search characteristics. For example, searching for the phrase “red pencil” on a keyword-based engine might produce results for the color red and for pencils, which is likely not the intended result. However, a syntax-based search engine would recognize the word “red” in context as a modifier for the word pencil, and would return results for red pencils. However, a syntax-based search engine cannot distinguish between many forms of ambiguity, even in such a simple search. Here, the term “red pencil” has two potential meanings: a pencil that is red on the outside, or a pencil that writes in the color red. Again, the user has to sort through the results to determine which ones fall within the meaning intended.

In semantic searches, multiple levels of context are used to provide results as close as possible to the user's likely intended meaning. For example, instead of taking into consideration only the word or phrase used in the search, the search engine will also consider numerous other variables, such as: the location of the user, the language or dialect in which the user is searching, the user's prior search history, search history and selections of users with similar characteristics (e.g., located in the same region), dictionary and thesaurus entries, website page ranks, website relational content, ontological groupings, taxonomies, natural language search engines, faceted searches (which group things into pre-defined high-level categories), clustered searches (which group things into topics extracted from the search results), lists of common ambiguities, and the like. For example, the search phrase “old race cars and drivers” has numerous possible meanings. It could be a historical reference to race cars and their (young at the time) drivers, or it could refer to young person's currently driving vintage automobiles, or it could refer to older persons currently driving vintage automobiles. It is not clear from the phrase whether the intended result is cars and drivers together or separately. It is also not clear what numbers of each type of thing are intended. For instance, it cannot be determined from the phrase alone whether the intended result would include individual cars with multiple drivers, multiple cars with multiple drivers, or individual drivers with multiple cars. However, in a semantic search, the entire context of the search would be taken into account such that an older person who has recently purchased a vintage automobile in an area known for its automobile clubs would likely be searching for a group of like-minded enthusiasts, and results would be provided accordingly. In a semantic search, the search engine itself is attempting, as closely as possible, to understand what the user intended when conducting the search, and to provide results that are as relevant as possible to that intent, so that the user doesn't have to perform the time-consuming work of sorting through and classifying the results. Some current search engines use limited semantic searching. For example, the search results for “football” on most search engines will produce different results, depending on whether the user is located in the United States or in the United Kingdom.

Knowledge graphs, which use defined ontologies to improve search accuracy, efficiency, and relevance, are on the rise. The use of ontologies and taxonomies is central to increasingly generalized search capabilities to capture human knowledge across a diverse set of domains, languages, and even dialects. The need for ontologies stems from the fact that human language, as opposed to machine specifications, can be ambiguous, non-literal, and redundant. When presented with a search, a service must determine not only that something is an entity, but what type and in what context. Most types of queries remain dependent on syntactic vs semantic search characteristics.

Semantic search has the potential to provide dramatically more accurate and useful searches. However, genuine semantic searches have not previously been possible due to the limitations previously stated regarding language ambiguities, lack of sufficient context, and the inability of existing ontologies to distinguish subtle distinguish subtle human expressions and intents.

In one embodiment, the system would continually search the internet for information, and build up one or more complex, relational databases using machine learning algorithms that automatically generate relationships between and among elements in the database(s) according to a large variety of factors. The resulting databases would contain complex hierarchical, taxonomical, and ontological relationships between elements which would enable the system to conduct semantic searches of information. In a similar manner, when the user enters a search query, the query and a large variety of contextual information about the user and the query would be analyzed using machine learning algorithms to predict the user's intent, even where such intent is unstated. The complex relational database(s) would then be searched using the results of the search query analysis to provide search results far exceeding those of current search engine technologies in terms of accuracy, relevance, and ease of use.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

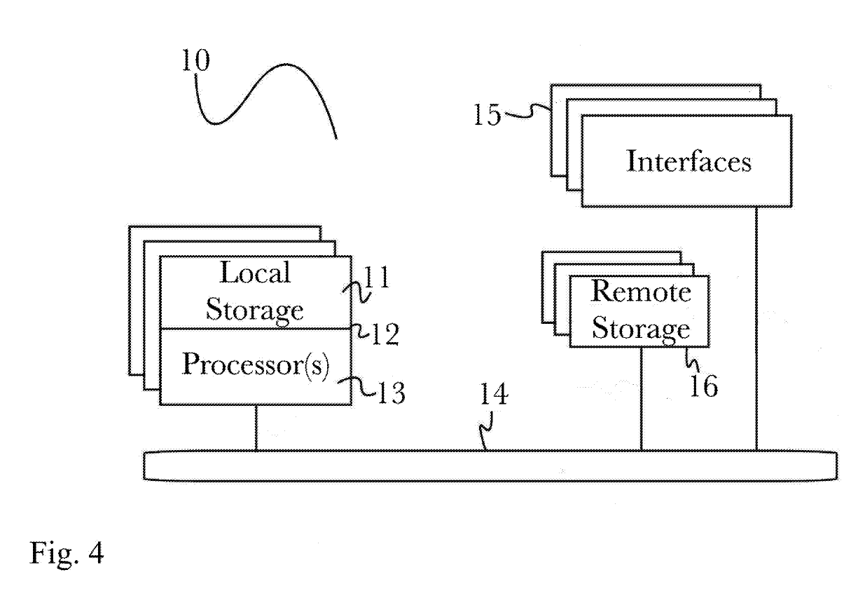

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

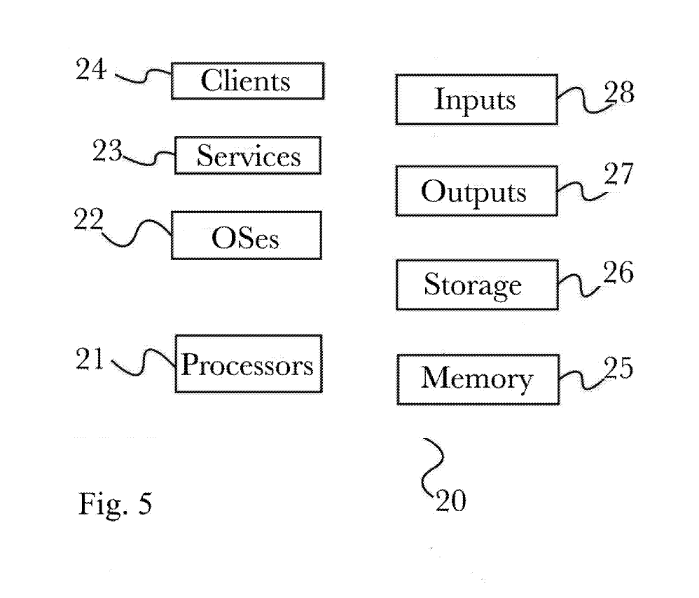

In some aspects, systems may be implemented on a standalone computing system. Referring now to FIG. 5, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

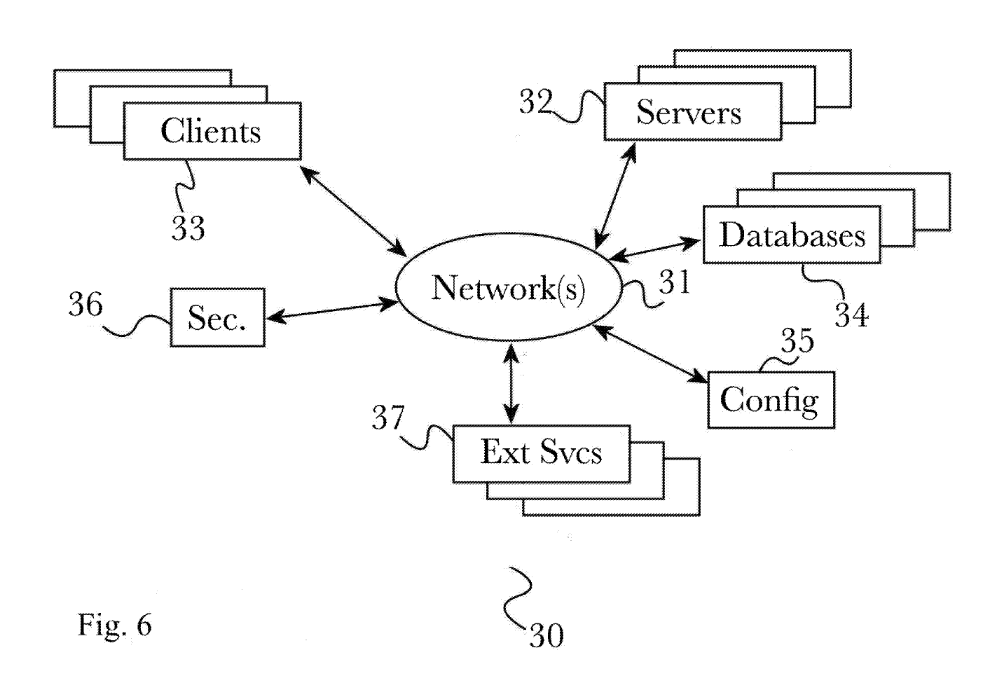

In some aspects, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as Wi-Fi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

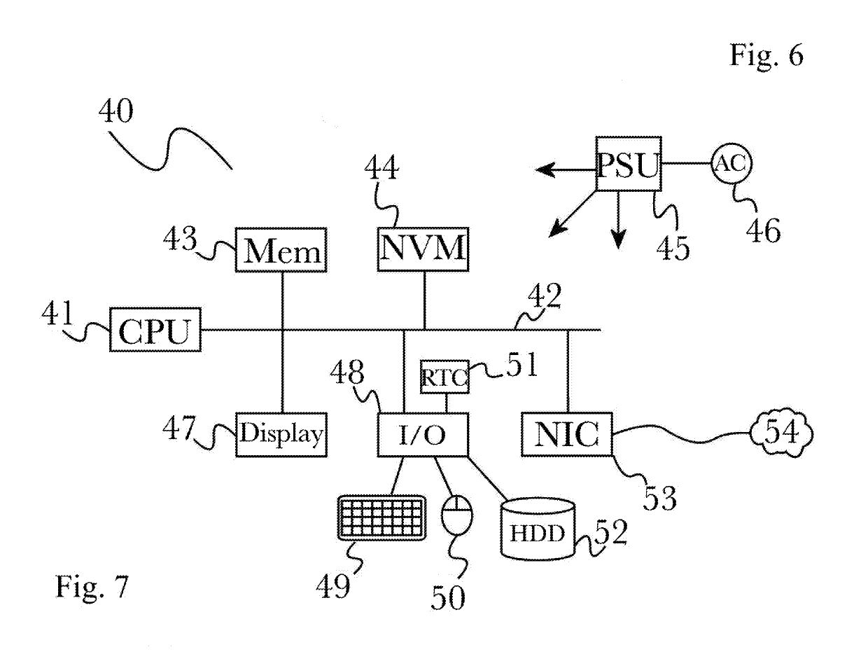

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

### Methods

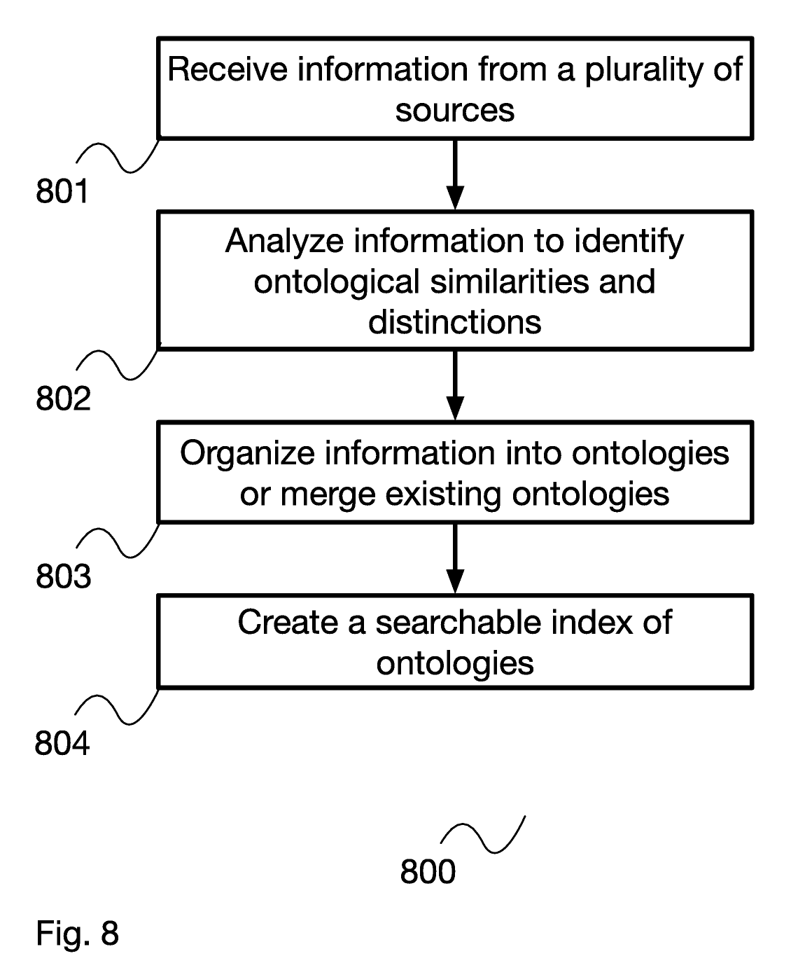

FIG. 8 is a method diagram 800 showing the steps involved in the automated creation of ontologies and searchable indices. Initially, information is received or gathered from a plurality of sources 801. As previously disclosed at 300, this information will come from a large variety of sources, many of which will be publicly available resources such as social media sites, government records, scientific journals, dictionaries, and the like. After the information is received, it is analyzed to identify ontological similarities and distinctions among the elements contained in the information 802. Based on the analysis, the information is then organized into organizing the information into ontologies based on the analysis either by creating new ontologies or merging existing ontologies 803. Finally, a searchable index of the ontologies is created 804, which facilitates semantic searches and other uses of the information.

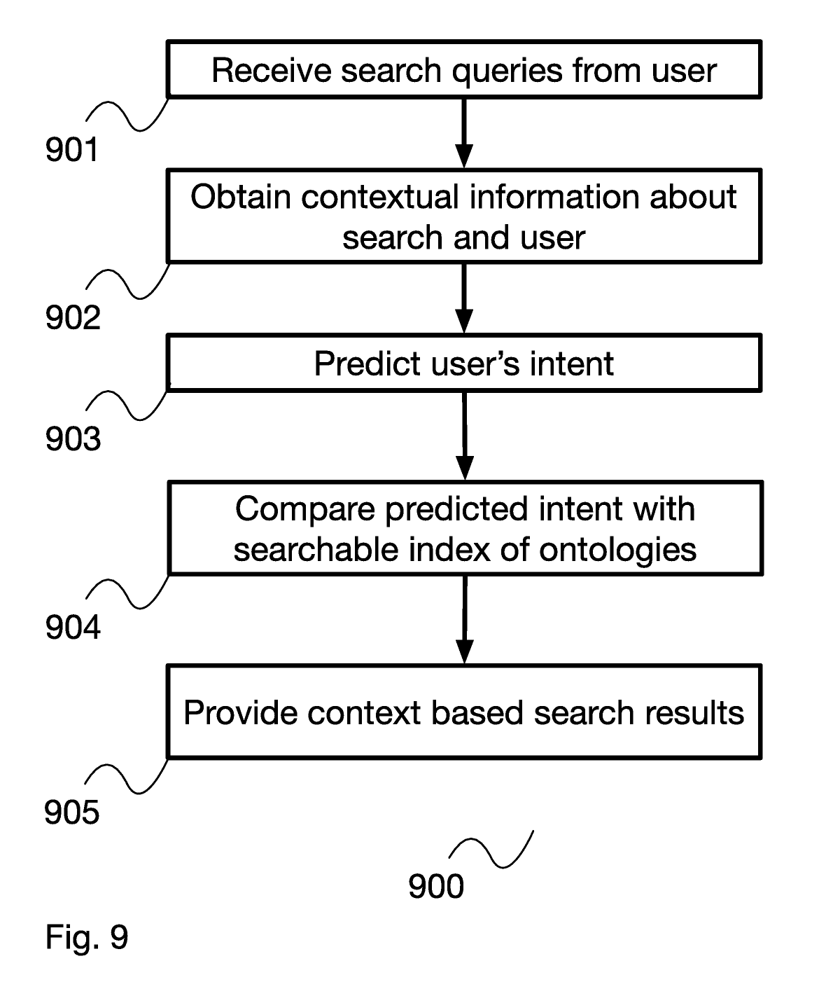

FIG. 9 is a method diagram 900 showing the steps involved in a semantic search using an indexed ontological database. After receiving a search query 901, contextual information is gathered about the search query and the user making the query 902. Based on the contextual information, a prediction is made about the user's intent 903, even where such intent is ambiguous or unstated. The predicted intent is compared with the searchable index of ontologies 904, and context based search results are provided to the user in response to the user's query 905.

What is claimed is:

1. A system for automatically creating and merging ontological databases of knowledge comprising:
an automated ontology engine comprising at least a processor, a memory, and a plurality of programming instructions stored in the memory and operating on the processor, wherein the programming instructions, when operating on the processor, cause the processor to:
receive information from a plurality of sources;
analyze the information to identify ontological similarities and distinctions among the elements contained in the information; and
organize the information into ontologies based on the analysis either by creating new ontologies or merging existing ontologies; and
an automated index generator comprising at least a processor, a memory, and a plurality of programming instructions stored in the memory and operating on the processor, wherein the programming instructions, when operating on the processor, cause the processor to create a searchable index of ontologies created by the automated ontology generator.

2. The system of claim 1 wherein the automatically generated ontologies are used to perform semantic searches, comprising:
a search handler comprising at least a processor, a memory, and a plurality of programming instructions stored in the memory and operating on the processor, wherein the programming instructions, when operating on the processor, cause the processor to:
receive search queries from users;
obtain contextual information about the search query and the user making the query;
predict the user's intent based on a contextual analysis of the search query itself and the user making the query;
compare the predicted user intent to the searchable index of ontologies from the automated index generator; and
provide context based search results to the user in response the search query.

3. A method for automatically creating and merging ontological databases of knowledge comprising the steps of:
(a) receiving information from a plurality of sources;
(b) analyzing the information to identify ontological similarities and distinctions among the elements contained in the information;
(c) organizing the information into ontologies based on the analysis either by creating new ontologies or merging existing ontologies; and
(d) creating a searchable index of ontologies created by the automated ontology generator.

4. The method of claim 3 wherein the automatically generated ontologies are used to perform semantic searches, comprising the steps of:
(a) receiving search queries from users;
(b) obtaining contextual information about the search query and the user making the query;
(c) predicting the user's intent based on a contextual analysis of the search query itself and the user making the query;
(d) comparing the predicted user intent to the searchable index of ontologies from the automated index generator; and
(e) providing context based search results to the user in response the search query.
